(19) United States
(12) Patent Application Publication
(10) Pub. No.: US 2019/0264485 A1
(43) Pub. Date: Aug. 29, 2019

(54) Upwardly Pivoted Window with Spring Biased Sash

(71) Applicant: Pioneer Window & Door Manufacturing Ltd., Winnipeg (CA)

(72) Inventors: Michael Marykuca, Winnipeg (CA); Evan Marykuca, Winnipeg (CA); Philip J. Ramer, Winnipeg (CA)

(21) Appl. No.: 16/283,018

(22) Filed: Feb. 22, 2019

(30) Foreign Application Priority Data
Feb. 23, 2018 (CA) 2996172
Jun. 26, 2018 (CA) 3009381

(51) Int. Cl. E05F 1/00

(52) U.S. Cl. CPC E05F 1/00; E05F 1/1091

(57) ABSTRACT

A window includes a sash which is pivotally connected at a top end by a top pivot to a perimeter frame so that a bottom end of the sash is pivotal upwardly through an arc of approximately 90 degrees from a closed position to an open position of the window. A linkage arm is pivotally coupled at a first end of the arm by a first pivot at an intermediate location along a side member of the sash and at a second end of the arm by a second pivot at an intermediate location along a side member of the perimeter frame. One of the top pivot of the sash or the second pivot of the linkage arm is a sliding pivot that is longitudinally slidable along the side member of the frame. A biasing member exert a biasing force on the sliding pivot which retains the sash open.

This application claims foreign priority benefits from Canadian Patent Application 2,996,172, filed Feb. 23, 2018 and Canadian Patent Application 3,009,381, filed Jun. 26, 2018.

### FIELD OF THE INVENTION

The present invention relates to a window having a sash which is pivotal about an upper horizontal axis to displace the bottom end of the sash upwardly and away from the window frame from a closed position to an open position of the window, for example a hopper window or an awning window, and more particularly the present invention relates to an upwardly pivotal window including a biasing member which exerts a force on the sash acting in an opening direction of the sash.

### BACKGROUND

A typical hopper or awning window comprises a perimeter frame defining a window opening therein, and a sash member which is pivotal mounted onto the perimeter frame about a horizontal pivot axis at a top end of the sash such that the bottom end of the sash is either pivoted inwardly into an interior of the building from a closed position to an open position in the instance of a hopper window or pivoted outwardly to the exterior of the building from the closed position to the open position in the instance of an awning window. Most commonly, the sash is pivoted at the top end thereof onto the top end of the perimeter frame so that the bottom of sash is pivoted upwardly along an arc shaped path from the closed position to the open position.

The usual design of a hopper window often includes the hinges formed with a first part on the frame defining a catch, and a second part on the sash defining a hook that can be selectively aligned with and retained in the catch to hold the window open. These are small metal hinges that are fastened to allow the user to lift the window up and then place the sash in an open position and then escape. The open position is obtained by lifting the sash past 90 degrees and then placing hooks on the catches of the hinges in the hold open position. The hinge is typically small and therefore cannot take a lot of sash weight as it acts as a cantilever and is very small in comparison. The hinges often flex and sometimes rip the screws out that hold them in place. This would not allow for triple glazed windows limiting the potential for an energy efficient basement window. The operation is not simple and often the user fails to be able to open the window past 90 degrees so that the hooks can reach the catches on the hinges for setting it in the hold open position. This contradicts what the code for egress windows says for the operation of the window without tools or special knowledge as it often requires special knowledge to get the window to successfully open and to hold the open position. The current hinge designs are not adjustable for sash position once they are fastened to the window.

Furthermore, the application of the hopper window is usually accompanied by a ceiling that is close to the top of the window. This often becomes a problem when the window must be opened past 90 degrees as the ceiling is in the way. Surface mount hardware also typically gets in the way of finishing trims used to finish the window.

Special cabinet hardware including gas cylinders, for example of the type used for lifting a rear gate on a vehicle, and friction hinges have been previously attempted for lifting hopper windows, but they have not been successful due to the cost and complications with hardware placement.

In the instance of an awning window, a linkage mechanism operated by a crank is typically connected between the bottom end of the sash and the perimeter frame so that the window can typically only be opened through a small range of less than 45 degrees for example due to the limitations of the linkage.

### SUMMARY OF THE INVENTION

According to one aspect of the invention there is provided a window assembly comprising:

a frame extending about a perimeter of a window opening in the frame, the frame including a top member spanning laterally across a width of the frame above the window opening, a bottom member spanning laterally across a width of the frame below the window opening, and a pair of side members spanning a height of the frame between the top member and the bottom member of the frame at laterally opposing sides of the window opening respectively;

a sash including a top member spanning laterally across a top side of the sash, a bottom member spanning laterally across a bottom side of the sash, and a pair of side members spanning between the top member and the bottom member of the sash at laterally opposing sides of the sash respectively;

a top pivot on the sash, the top pivot pivotally coupling side members of the sash to the side members of the frame adjacent top side of the window opening for pivotal movement about a laterally oriented pivot axis such that the sash member is movable relative to the frame between a closed position spanning across the window opening and an open position in which the bottom member of the sash is pivoted upwardly and away from the frame relative to the closed position such that the window opening is at least partially unobstructed by the sash;

at least one linkage arm including a first pivot at a first end of the linkage arm which is operatively connected for relative pivotal movement to one of the side members of the sash at an intermediate location between the top member and the bottom member of the sash and a second pivot at a second end of the linkage arm which is operatively connected for relative pivotal movement to one of the side members of the frame at an intermediate location between the top member and the bottom member of the frame;

one of the top pivot, the first pivot or the second pivot comprising a sliding pivot that is operatively connected to the respective side member upon which the pivot is supported so as to be longitudinally slidable relative the side member in a longitudinal direction of the side member; and

a biasing member operatively connected to the sliding pivot so as to bias the sliding pivot longitudinally inwards along the respective side member towards another one of the pivots on that side member so as to exert a biasing force acting on the sash in a direction urging the sash towards the open position.

In some embodiments, the window assembly is a hopper window in which the bottom end of the sash is pivoted inwardly from the closed position to the open position.

In preferred embodiments for a hopper window, one of the top pivot or the second pivot comprises the sliding pivot, and the biasing member exerts a biasing force acting on the sash in the open position to retain the sash in the open position.

Alternatively, the window assembly may be an awning window in which the bottom end of the sash is pivoted outwardly from the closed position to the open position.

In a preferred embodiment for an awning window, the first pivot is the sliding pivot and the biasing member urges the sliding pivot towards the top pivot.

When the window assembly is an awning window, preferably the window assembly further comprises an operator mechanism for opening the window which is operatively connected between one of the side members of the sash and one of the side members of the frame such that the operator mechanism does not provide any obstruction that would otherwise prevent the use of the awning window as an egress window.

The sliding pivot is preferably supported on a sliding member which is received within a hollow channel within the respective side member of the frame in which the sliding member mates with the hollow channel so as to be linearly slidable along the channel.

The biasing member is preferably also supported within a hollow channel within the side member of the frame.

The pivot system described herein at least partially overcomes some the limitations of the existing designs available. The pivot point is moved further out onto the sash allowing for less stress on the hardware and the potential for a heavier sash thus allowing for triple glazed energy efficient options. The hardware fastening method dose not undergo a lot of stress alleviating the potential for failure of the fasteners. The operation is very simple and requires no special knowledge to open the window.

In the instance of a hopper window, the user unlocks the window using commonly found sash locks and simply lifts the window upward to the fully open position. The bias system holds the window open making for proper egress ability. This does not require special knowledge and does not contradict the building code in any way. Low ceilings are never a limitation for this window design because the window does not have to be opened past 90 degrees. In the instance of an awning window, an additional operator mechanism can be provided to assist in opening the window.

The new pivot system described herein is also very manufacturing friendly as it is a completely adjustable system allowing the manufacture to adjust sash position post assembly. The hardware can also be concealed so that finishing the window will be easier as there is no surface mount hardware that needs to be worked around.

According to one embodiment of the present invention, the top pivot may be the sliding pivot such that the biasing member biases the top pivot downwardly towards the second pivot in the open position of the sash. In this instance, the first pivot may be fixed in longitudinal position along the side member of the sash and the second pivot may be fixed in longitudinal position along the side member of the frame.

Alternatively, according to a preferred embodiment of the present invention, the second pivot of said at least one linkage arm is the sliding pivot such that the biasing member biases the second pivot upwardly towards the top pivot in the open position of the sash.

The preferred embodiment may include (i) a lower stop member supported on the side member of the frame below the second pivot which is arranged to be engaged by the second pivot to prevent further downward sliding movement of the second pivot along the side member as the sash is displaced towards the closed position, and/or (ii) an upper stop member supported on the side member of the frame above the second pivot which is arranged to be engaged by the second pivot to prevent further upwardly sliding movement of the second pivot along the side member beyond the open position of the sash.

In some arrangements, the biasing member may be supported above the second pivot such that the biasing force pulls upwardly on the second pivot below the biasing member; however, in alternative arrangements the biasing member may be supported below the second pivot such that the biasing force pushes upwardly on the second pivot above the biasing member.

In the preferred embodiment, the top pivot may be operatively connected to the side members of the frame so as to be longitudinally slidable relative to the side members of the frame in the longitudinal direction of the side members in addition to the second pivot which defines the sliding pivot operatively connected to the biasing member. In this instance, a stop member may be supported on the side member of the frame below the top pivot so as to prevent downward sliding movement of the top pivot beyond the stop member.

The first pivot may also be operatively connected to the side member of the sash so as to be longitudinally slidable relative to the side member in a longitudinal direction of the side member. Preferably the first pivot is limited to sliding over only a minor portion of the overall length of the side member of the sash by use of a stop member supported on the side member of the sash below the first pivot. The stop member is preferably arranged to be engaged by the first pivot to prevent further sliding movement of the first pivot along the side member towards the bottom member of the sash in the open position of the sash.

Alternatively, the first pivot may be fixed in longitudinal position along the side member of the sash.

In the instance of an awning window, when the sliding pivot is supported on a sliding member which is longitudinally slidable within a hollow channel within the respective side member of the frame, an operator handle is preferably connected to the sliding member so as to protrude from the side member of the frame through a longitudinal slot in the side member of the frame such that the operator handle is accessible at an interior side of the window assembly in the closed position. The window assembly may further include a plurality of detents formed along the longitudinal slot in which each detent receives the handle therein in a respective one of a plurality of intermediate positions between the open and closed positions so as to retain the sash in the respective one of the intermediate positions.

### BRIEF DESCRIPTION OF THE DRAWINGS

Various embodiments of the invention will now be described in conjunction with the accompanying drawings in which:

FIG. 1 is first perspective view of the window assembly according to a first embodiment, shown as a hopper window in an open position.

FIG. 2 is a second perspective view of the window assembly according to the first embodiment, also shown in the open position;

FIG. 3 is a sectional view along the line 3-3 in FIG. 2;

FIG. 4 is a sectional view along the line 4-4 in FIG. 2;

FIG. 5 is an exploded view of various components of the window assembly shown separated from the perimeter frame and the sash;

FIG. 6 is a schematic, partly sectional, side elevational view of the window assembly according to the first embodiment;

FIG. 7 is a sectional view along the line 7-7 of FIG. 6;

FIG. 8 is a schematic, partly sectional, side elevational view of the window assembly according to a second embodiment in a hopper window configuration;

FIG. 9 is a schematic, partly sectional, side elevational view of the window assembly according to a third embodiment in a hopper window configuration;

FIG. 10 is a perspective view of the window assembly according to a fourth embodiment in an awning configuration;

FIG. 11 is a schematic representation of the window assembly according to the awning configuration of the fourth embodiment in an intermediate position of the window partway between the open and closed positions;

FIG. 12 is a sectional view along the line 12-12 in the fourth embodiment of the window assembly in FIG. 10;

FIG. 13 is a perspective view of the window assembly according to a further embodiment in an awning window configuration, shown in a partly open position;

FIG. 14 is a sectional view generally along the line 14-14 in FIG. 13 of the side members at one side of the window assembly according to the embodiment of FIG. 13; and

FIG. 15 is a schematic side elevational view of the window assembly according to the embodiment of FIG. 13 in a partly open position.

In the drawings like characters of reference indicate corresponding parts in the different figures.

### DETAILED DESCRIPTION

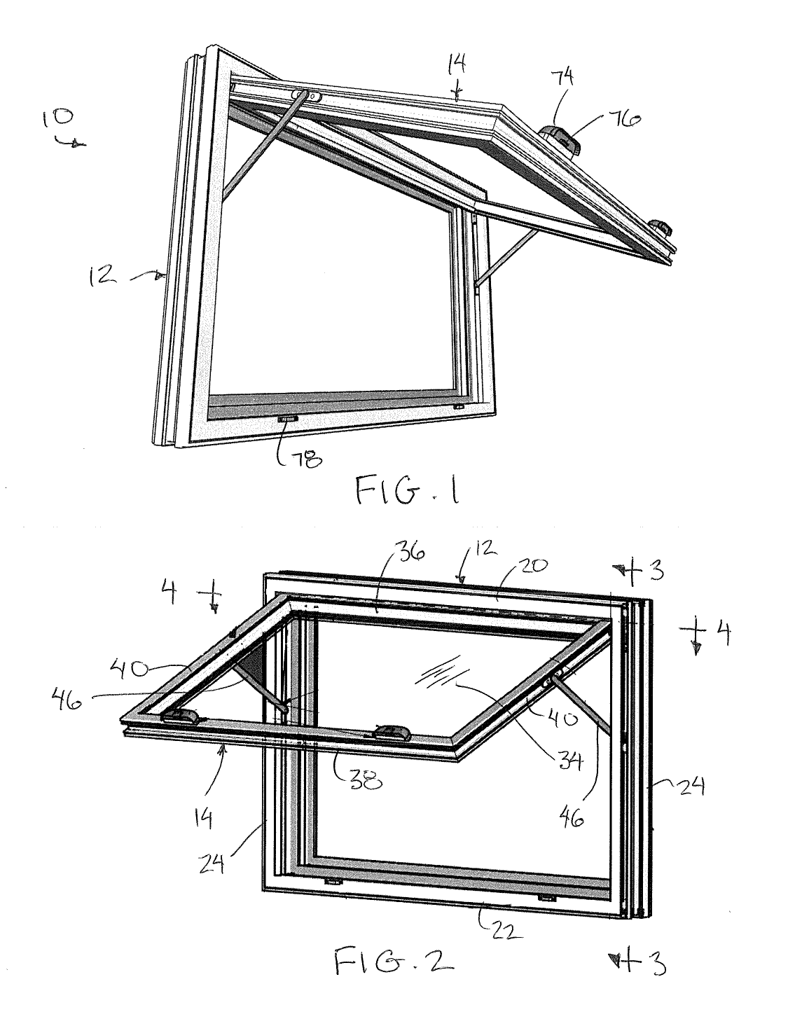

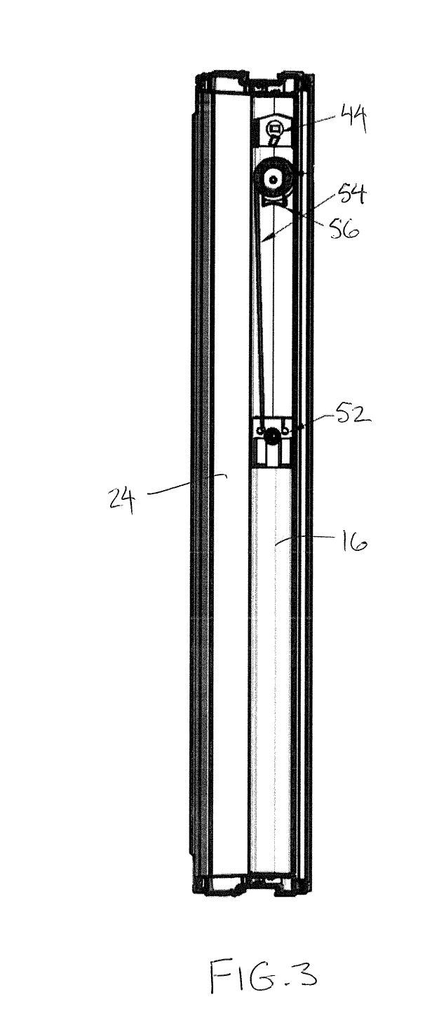

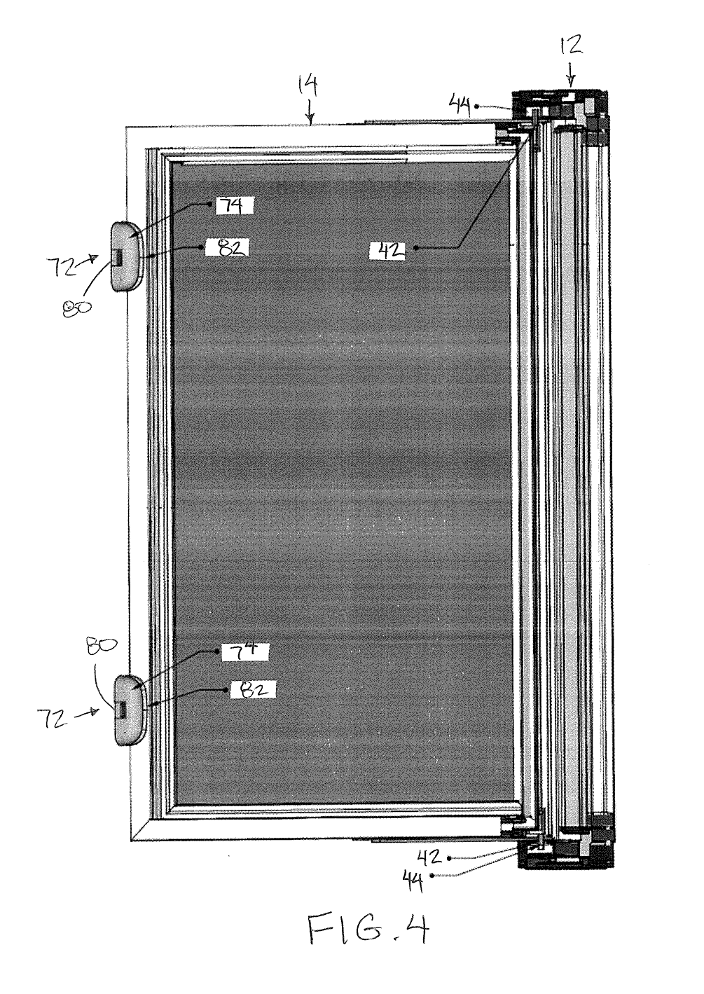

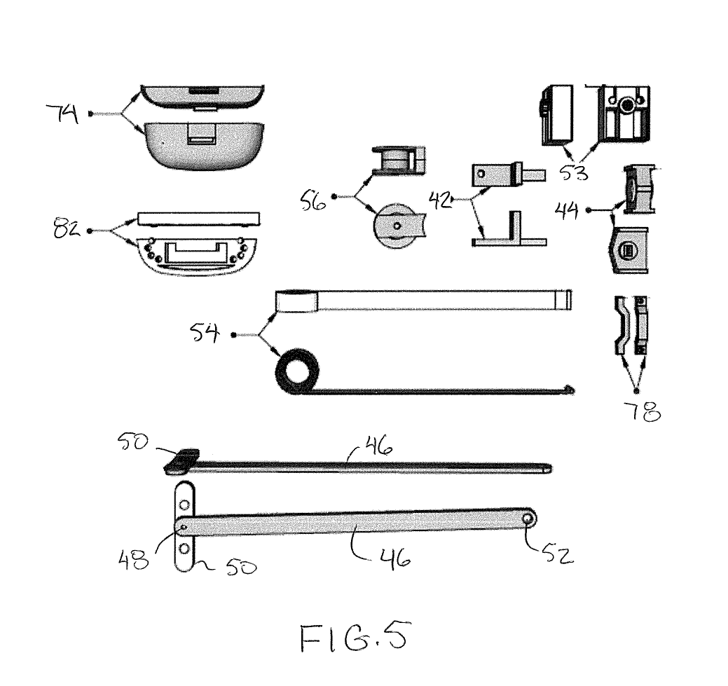

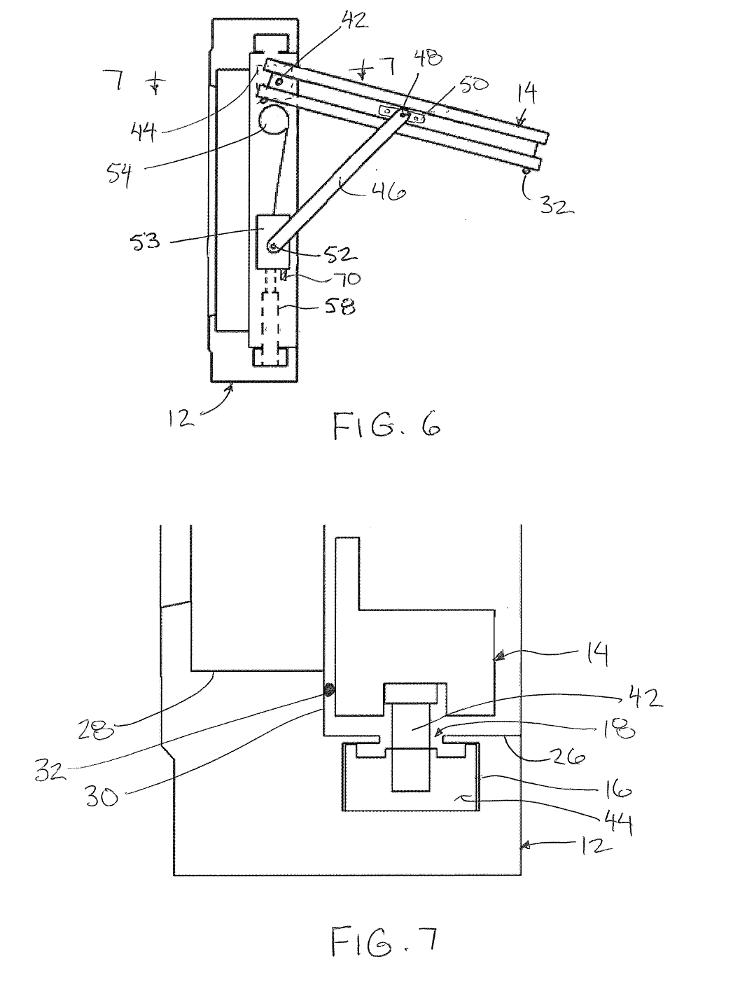

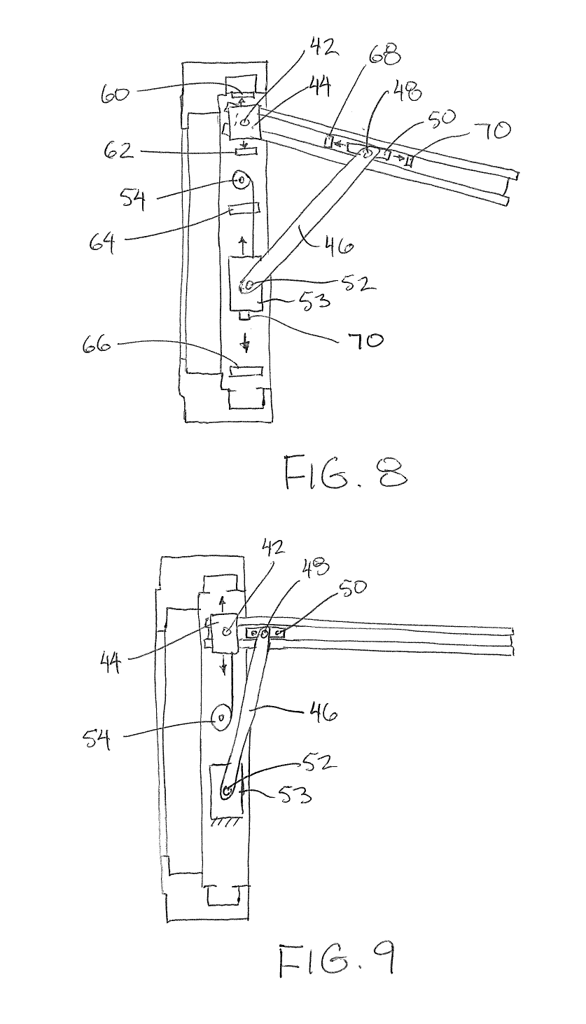

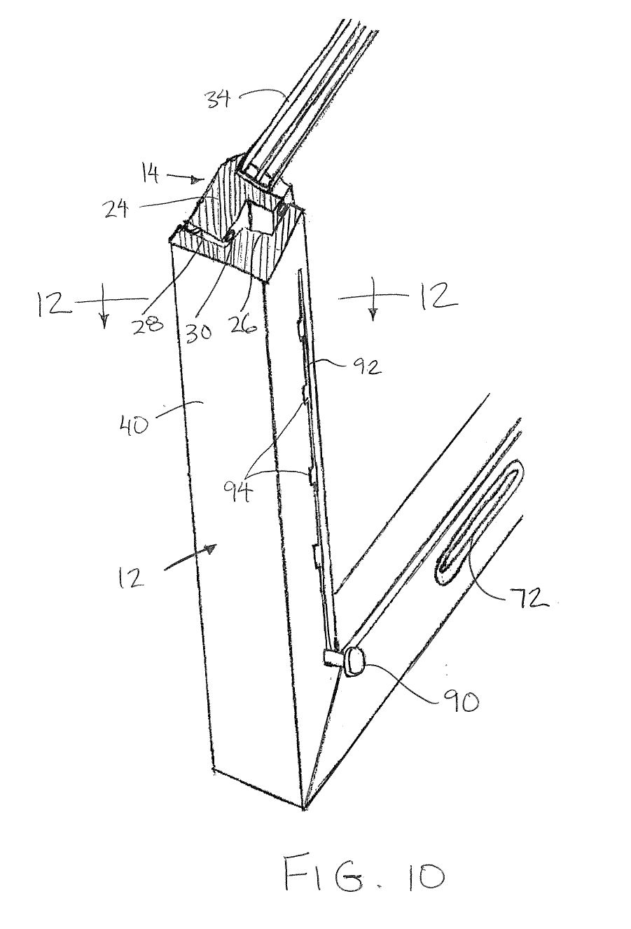

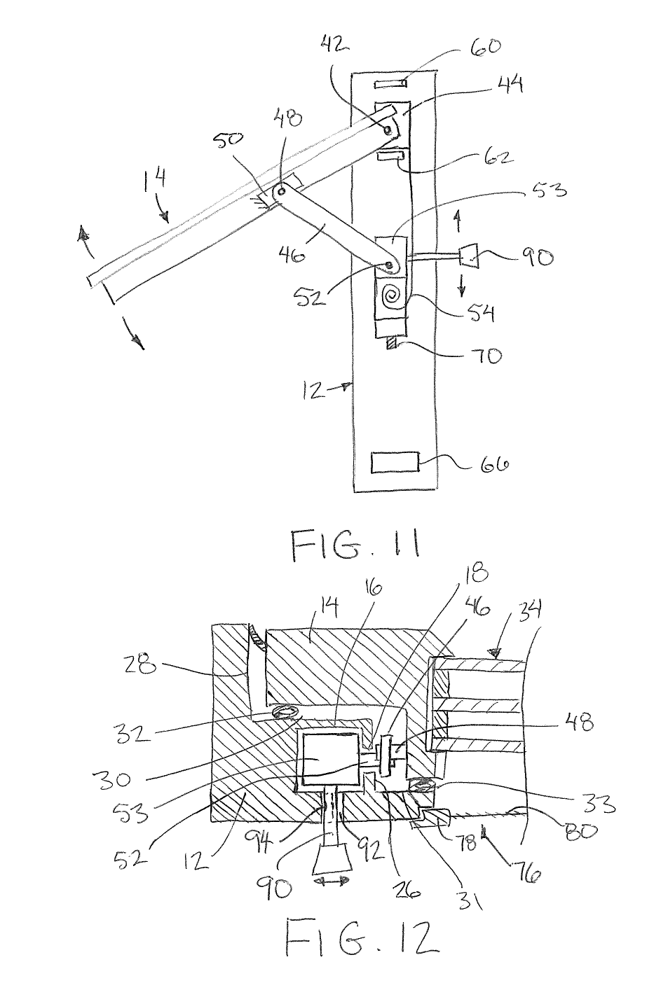

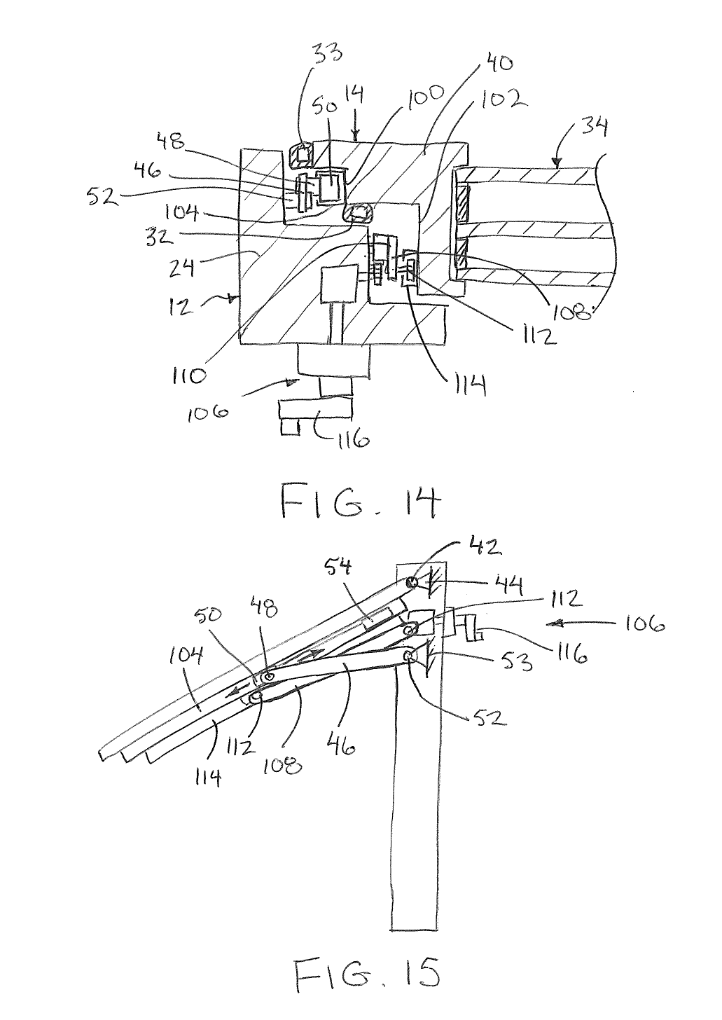

Referring to the accompanying figures there is illustrated a window assembly generally indicated by reference numeral 10. The window assembly may be configured as a hopper window according to FIGS. 1 through 9, or as an awning window according to FIGS. 10 through 14.

In each instance, the window assembly generally comprises a perimeter frame 12 extending about a window opening, and a sash 14 which is operatively connected to the perimeter frame for movement between a closed position spanning across the window opening in the frame and an open position in which the bottom end of the sash has been swung through an arc of near 90° upwardly and inwardly into the interior of a building space from the closed position towards the open position.

The perimeter frame is formed of a set of four pieces of an extruded profile which have been suitably cut for assembly into the perimeter frame. The shape of the profile in a cross-sectional plane perpendicular to the longitudinal direction of the profile includes an integral hollow channel 16 formed therein which is partially open at the inner side thereof by a slot 18 so that various operating components of the window assembly can be mounted and concealed within the hollow channel 16 while enabling connection of the components within the channel to other components external of the channel through the slot 18.

More particularly, the perimeter frame includes a top member 20 spanning laterally across a width of the frame above the window opening at the top of the frame. A bottom member 22 spans in the lateral direction across the full width of the frame below the window opening at the bottom of the frame. Two side members 24 span a full height of the frame between the top member 20 and the bottom member 22 at laterally opposing sides of the window opening corresponding to laterally opposing ends of the frame. In each instance, the profile is oriented such that the slot 18 faces inwardly towards the opposing corresponding member of the perimeter frame.

Turning now more particularly to FIGS. 1 through 9, the inner side of the profile forming each member of the perimeter frame is generally stepped in profile so as to define an inner portion 26 at the inner side of the window frame which is positioned to define the portion of the opening receiving the dimensions of the sash 14 therein, and an outer portion 28 which is stepped inwardly relative to the inner portion and which is located towards the outer side of the window frame. In this manner, the lateral width between the outer portions 28 of the two side members is less than the width between the inner portions 26 of the two side members. Similarly, the height between the inner portions of the top and bottom members is greater than the height between the outer portions of the top and bottom members respectfully as a result of the stepped profile. The inner portion 26 locates the hollow channel 16 and the slot 18 therein.

The inner side of each profile further includes a stepped face 30 joining the inner portion 26 and the outer portion 28 such that the stepped face 30 of all four members of the perimeter frame lie in a common plane spanning across the window opening. In the closed position of the sash, a sealing member 32 which is formed of resiliently deformable material, is provided on the exterior face of the sash about the full perimeter thereof for abutment against the stepped face 30 of the perimeter frame to provide a weather sealing strip between the closed sash and the perimeter frame.

The sash 14 receives a glass insert 34 therein which forms the transparent portion of the window assembly. A frame portion of the sash surrounds the glass insert. Similarly to the perimeter frame, the frame portion of the sash is assembled from four pieces of an elongate extruded profile which has been cut to length and then assembled to form a perimeter surrounding the glass insert 34.

More particularly, the frame portion of the sash includes a top member 36 spanning in the lateral direction across a top side of the sash across a full width of the sash such that the full width is readily received within a width of the perimeter frame defined between the inner portions 26 of the two side members 24 thereof. A bottom member 38 spans across the full width of the sash along the bottom side thereof. The frame portion of the sash also includes two side members 40 at laterally opposing ends of the sash to span the full height of the sash between the top member and the bottom member thereof at opposing sides of the glass insert. The full height of the sash as defined by the side members 40 is configured to fit within the height of the perimeter frame as defined between the inner portions 26 of the top member and the bottom member thereof. An outer face portion of each of the top member, the bottom member, and the two side members is arranged to lie in parallel abutment with the corresponding stepped faces 30 of the perimeter frame in the closed position of the sash to provide corresponding surfaces between which the sealing member 32 is received to provide a weather tight seal between the sash and the perimeter frame.

A top pivot is provided on the sash in the form of two stub shafts 42 mounted in fixed relation onto the two side members of the sash adjacent the top side of the sash respectively. The two stub shafts protrude laterally outwardly from opposing ends of the sash along a common pivot axis oriented in the lateral direction in close proximity to the top of the sash. Two pivot mounts 44 are mounted within the hollow channels of the two side members 24 of the perimeter frame respectively which define suitable sockets receiving the two stub shafts 42 therein respectively adjacent the top end of the perimeter frame. In this manner, the top pivot supports the sash for pivotal movement relative to the frame between a closed position spanning across the window opening, and an open position in which the bottom of the sash has been displaced upwardly and inwardly through an arc of near 90° to the open position.

A linkage arm is provided in the form of two link members 46 operatively connected to laterally opposing side members 40 of the sash respectively. Each link member 46 is also operatively connected to a respective one of the side members 24 of the frame as described in further detail below.

More particularly each link member includes a first pivot 48 at the first end thereof in the form of a shaft which is received within a corresponding first pivot mount 50 supported at an intermediate location between the top member and the bottom member of the sash. Each link member also includes a second pivot 52 in the form of a shaft which is received within a corresponding second pivot mount 53 received within the hollow channel of the side member 24 of the perimeter frame at an intermediate location between the top member and the bottom member of the frame.

Depending upon which embodiment being referred to below, one of the second pivot on the linkage arm or the top pivot is supported with the pivot mount thereof being mated within the hollow channel for linear sliding movement along the channel such that the pivot defines a sliding pivot which varies in height along the side member of the perimeter frame.

A biasing member 54 is further provided within the hollow channel of both side members of the perimeter frame for connection between the perimeter frame and the pivot mounts of the sliding pivots respectively such that the biasing member exerts a force which is sufficient to hold the sash in the open position once the sash has been positioned in the open position.

In order to retain the window locked in the closed position, a pair of the latch assemblies 72 are provided in which each latch assembly includes a housing 74 and a catch pin 76 mounted within the housing which is biased into a locking position protruding outwardly from the bottom of the housing in the closed position of the window assembly. A suitable striker member 78 is mounted on the bottom member of the perimeter frame to define a socket which selectively receives the catch pin therein in the locked position. A knob 80 mounted on the exterior of the housing is connected to the catch pin 76 such that upward deflection of the knob 80 causes the catch pin to be retracted upwardly into the housing against the biasing force of an internal spring to release the catch pin from the striker 78 for unlocking the latch assembly and enabling the window to be pivoted from the closed position towards the open position. A suitable spacer plate 82 is provided which can be fastened between the housing 74 of the latch assembly and the inner face of the sash to allow for proper alignment of the catch pin with the striker 78.

Turning now more particularly to the first embodiment shown in FIGS. 1 through 7, in this instance, the top pivot mounts 44 may be mounted in fixed relation to the side members of the perimeter frame. Similarly, the first pivot mounts 50 of the first pivot 48 of the link members 46 may be mounted in fixed relation to the side members of the sash. Accordingly, it is the second pivot mounts 53 of the second pivots 52 which define the sliding pivot in this instance by being supported for longitudinal sliding along the respective side member of the perimeter frame. The biasing member 54 in this instance comprises a coil spring member which supported on a support barrel 56 at a fixed location along the side member of the perimeter frame above the second pivot but below the top pivot. An end portion of the spring member 54 can be extended for connection to the pivot mount of the second pivot therebelow with the biasing of the spring acting to recoil the spring member to exert an upward pulling force on the second pivot. The force exerted by the spring is sufficient to retain the sash in the open position once opened.

Optionally, the biasing member 54 in the first embodiment may comprise a gas cylinder 58 or other suitable mechanism mounted below the pivot mount of the second pivot to exert an upward pushing force on the second pivot instead of the pulling force of a coil spring above the second pivot.

Turning now more particularly to FIG. 5, some of the various components of the window assembly will now be described in further detail. Additional views are also provided in FIG. 5 of the barrel 56 which supports the coil spring 54 of the biasing member thereon. Details of the mounting brackets of the two stub shafts 42 are also illustrated in FIG. 5 which enable fastening onto the frame members of the sash respectively. Two views of the top and pivot mounts 44 and of the sliding second pivot mounts 53 are also provided in FIG. 5 in which the mounts are shown separated from the hollow channel of the side member of the perimeter frame within which they are received in the assembled configuration. FIG. 5 also illustrates two views of one of the link members 46 which is pivotally coupled to a first pivot mount 48 at the first end thereof and in which the first pivot mount is shown to include fastener apertures for mounting at a fixed location along the side members of the sash respectively in a manner consistent with the first embodiment.

Turning now to the second embodiment of FIG. 8, in this instance the top pivot formed by the stub shafts 42 may also be mounted within respective pivot mounts which are longitudinally slidable in height along the length of the side members of the perimeter frame respectively in addition to the sliding of the second pivot mounts. The top pivots however are constrained to slide longitudinally through a much smaller range than the range of the second pivots by use of a first stop member 60 mounted in the hollow channel above the top pivot and a second stop member 62 mounted in the hollow channel below the top pivot to define upper and lower limits to the sliding movement of the top pivot relative to the perimeter frame. The second stop member below the top pivot for instance acts to prevent downward sliding movement of the top pivot beyond the stop member so as to avoid interference with the biasing member below.

According to the second embodiment of FIG. 8, there may also be provided an upper stop member 64 mounted in the hollow channel above the second pivot mount and a lower stop member 66 mounted in the hollow channel below the second pivot mount to define upper and lower limits of travel of the second pivot mount along the side members of the perimeter frame. The lower stop member may be arranged to be engaged by the second pivot mount to prevent further downward sliding movement of the second pivot mount along the side member as the sash is displaced toward the closed position. The upper stop member is arranged to be engaged by the second pivot member to prevent further upward sliding movement of the second pivot mount along the side member beyond the open position of the sash.

The embodiment of FIG. 8 may also be distinguished from the first embodiment by configuring the first pivot mounts of the linkage arms to be longitudinally slidable in the longitudinal direction of the side members of the sash. In this instance a first stop member 68 may be mounted on the side member of the sash above the first pivot mount and a second stop member 70 may be mounted on the side member of the sash below the first pivot mount to define upper and lower limits to the longitudinal sliding of the first pivot mount along the side member of the sash. The first pivot mount is constrained along a much smaller distance of longitudinal sliding along the sash than the permitted range of longitudinal sliding of the second pivot of the linkage arm along the side members of the perimeter frame.

As described herein, the frame is initially assembled using 4 pieces of slider sash that have a pocket or hollow channel therein for a contained balance system that are cut to be sized for the frame of the window. A typical slider sash that accompanies this slider frame is cut for the sash of the hopper. Using calculations, the weight of the sash is determined. The sash weight and all the pivot points and the final position of the system determine the amount of required force to hold the window in the open position (typically 90 degrees from the closed position). The sash must be cut to fit the frame so that a weather tight seal is obtained. If pre-installed weather-strip is not on the sash for frame this must be installed to create the weather seal. Next, a moveable block is installed into the frame of the window. A linkage arm is mounted to the sash of the window at a point along the sash. The movable block must have an attachment method for the end of the linkage arm not attached to the sash. Using a block and pivots installed onto the sash and the frame allows the sash to pivot outwards from the window. The closer this pivot to the edge of the frame the bigger egress area obtained. The manufacturer then installs the sash into the frame and then installs a mechanism to apply force to the moveable block and or the pivot block to apply force to the pivot points to hold the window open. The amount of force should be in equilibrium when the window is in the open position. Coils springs or cylinders can be used to apply this force but are not limited to this. All the system is placed behind the protection of the main weather seal much like todays casement windows. The mechanism is robust and very forgiving in the case of poor installations.

Turning now to a third embodiment shown in FIG. 9, in this instance both the first pivot mounts of the first pivots and the second pivot mounts of the second pivots of the linkage arm are fixed in the longitudinal positions along the respective side members of the sash and the perimeter frame respectively. Accordingly, in this instance it is the top pivot and the corresponding top pivot mounts 44 which define the sliding pivots that are mounted for longitudinal sliding along the respective side members of the perimeter frame respectively. The biasing member 54 in this instance is again mounted within the hollow channel of the side members of the perimeter frame; however, one end of the biasing member is coupled at a fixed location onto the perimeter frame while the opposing end is coupled to the sliding mount of the top pivot with the biasing member being supported under tension to exert a downward force on the top pivot in the open position of the sash. The force is sufficient to hold the sash in the open position once the operator has pivoted the window into the open position.

Turning now to the fourth embodiment shown in FIG. 10, in this instance, the sash is pivoted from the closed position to the open position such that the bottom end of the sash is displaced upwardly and outwardly towards the exterior of the building supporting the window therein in the configuration of an awning window.

When used as an awning window, the inner side of the profile forming each member of the perimeter frame is again stepped in profile so as to define an inner portion 26 at the interior side of the window frame and an outer portion which is located towards the outer side of the window frame; however, in this instance it is the outer portion 28 which is positioned to define a portion of the opening receiving the dimensions of the sash therein. Accordingly, the lateral width and height between opposing outer portions 28 of the profiles about the perimeter frame corresponds approximately to the width and height of the sash, however, the lateral width between the inner portions of the two side members is less than the width between the outer portions of the two side members. Similarly, the height between the outer portions of the top and bottom members is greater than the height between the inner portions of the top and bottom members respectively as a result of the stepped profile.

The inner side of each profile also includes a stepped face 30 joining the inner portion 26 and the outer portion 28 such that the stepped face 30 of all four members of the perimeter frame lie a common plane spanning across the window opening. In the closed position of the sash, a sealing member 32 formed of resiliently deformable material is provided on the interior face of the sash about the full perimeter thereof for abutment against the stepped face 30 of the perimeter frame to provide a weather sealing strip between the closed sash and the perimeter frame.

The profiles about the perimeter frame may be further shaped to define an inner face 31 for abutment with a second corresponding face at the interior side of the sash so that a second sealing member 33 formed of resilient material provides a secondary weather sealing strip between the closed sash and the perimeter frame.

The sash 14 includes a top member 36, a bottom member 38, and two side members 40 to form the full perimeter about a glass insert 34 received therein in a manner similarly to the previous embodiments. Also similarly to the previous embodiments, a pair of stub shafts 42 protrude laterally outwardly from opposing ones of the side members 40 adjacent the top end thereof to define a common horizontal pivot axis of the sash relative to the perimeter frame of the window. The shafts 42 are received within respective top pivot mounts 44 received within the hollow channel 16 of the two side members 24 of the perimeter frame. The top pivot mounts 44 may be longitudinally slidable within the hollow channels between an upper stop 60 and a lower stop 62 through a small range of relative sliding movement defined between the stops as described in further detail below.

Two link members 46 are again provided at laterally opposing sides of the sash such that each link member is pivotally mounted at a first pivot 48 at a first end of the link member on a first pivot mount 50 at a fixed location along the respective side member of the sash at an intermediate location spaced from both the top and bottom ends of the sash. Each link member is further pivotally mounted at a second pivot 52 at a second end of the link member on a second pivot mount 53. Each second pivot mount is longitudinally slidable within the hollow channel 16 at the respective side member of the perimeter frame of the window assembly.

A biasing member 54 is coupled to each sliding pivot mount 53. The biasing member 54 comprises a recoiling mechanism which is biased to retract an elongate spring member into the recoiling mechanism. The free end of the spring member is anchored to the top pivot mount 44 of the top pivot while the recoiling mechanism is anchored below the sliding pivot mount 53 so as to both bias the upper pivot mount 44 downward against the bottom stop 62 while also biasing the sliding pivot mount 53 upwardly in a direction to cause the sash to be displaced from the closed position towards the open position.

As in the previous embodiments, the sash is movable through a range of different intermediate positions at different spacings between the closed position and the open position. As the sash is initially displaced away from the open position, the second pivot mount 53 is urged to continue to slide upwardly by the biasing mechanism while simultaneously pulling the top pivot mount 44 downward against the lower stop 62.

As the sash is displaced toward the closed position, the link members 46 cause the second pivot mounts 53 to be slidably displaced downwardly until the assembly of components connected to the second pivot mount 53 engage a bottom stop 66 at which point the sash is near to vertical in orientation in proximity to the closed position. Continued urging of the sash towards the closed position once the bottom stop 66 has been engaged will then force the top pivot mount 44 upwardly towards the upper stop 60 for suitably aligning the sash with the opening defined by the outer portion 28 of the window frame.

An adjustable screw member 70 can be mounted at the bottom of the second pivot mount assembly 53 for engagement with the bottom stop 66 as the sash approaches the closed position. Rotating the screw 70 will adjust the height of the bottom end of the screw relative to the second pivot 52 which in turn assists in adjusting the alignment of the sash relative to the perimeter frame as the sash approaches the closed position. The screw member 70 may be incorporated into any of the previous embodiments for similar purposes of aligning the sash with the opening in the perimeter frame.

The perimeter frame may be adapted at the interior side thereof for mounting of a screen assembly 76 therein. The screen assembly includes a screen frame 78 extending about a perimeter of the screen assembly for selective coupling to the inner side of the perimeter frame of the window assembly. A panel of screen material 80 spans across the central opening in the screen frame 78 for spanning across the window opening.

To provide access for an operator at the interior side of the window to control positioning of the sash between the open and closed positions thereof when a screen assembly 76 is present, a handle member 90 is mounted in fixed relation to the second pivot mount 53 for longitudinal sliding along the side member of the perimeter frame together with the second pivot mount. The handle member 90 protrudes outwardly from the channel 16 in the side member of the frame 12 at the interior side of the window assembly by orienting the handle to protrude horizontally outward through a longitudinal slot 92 formed in the profile of the window frame. More particularly the longitudinal slot is located at the interior side of the perimeter frame 12 in open communication with the hollow channel 16 along the length thereof. In this manner the handle can be readily grasped by an operator to displace the handle vertically up and down along the side member of the perimeter frame which in turn causes the sash to be pivoted between the open and closed positions by the operative connection of the sash to the sliding pivot mount 53 through the link member 46.

The longitudinal slot 92 is further provided with a plurality of detents 94 formed along one of the longitudinally extending edges of the slot at longitudinally spaced apart positions therealong. Each detent is arranged to receive the handle 90 therein in a corresponding one of the intermediate positions of the sash between the open and closed positions thereof. Each detent 94 defines a catch for retaining the handle thereon to prevent upward or downward movement of the handle and thus prevent any pivotal displacement of the sash away from the corresponding intermediate position when the handle is received within the respective detent 94. The handle may be arranged to be flexed or pivoted to displace the handle laterally into and out of the detents 94 as the handle is displaced longitudinally along the slot 92 for alignment with the different detents 94 respectively.

The window assembly according to FIG. 10 further includes a latch assembly 72 which is similar to the latch assembly of the previous embodiments for selectively retaining the sash in the closed position when locked.

Other than the configuration of the window as an awning window and the use of the handle 90 to provide an operator access for displacing the sash between open and closed positions and/or retaining the sash in a selected intermediate position, the window assembly according to the fourth embodiment of FIGS. 10 through 12 operates similarly to the previous embodiments.

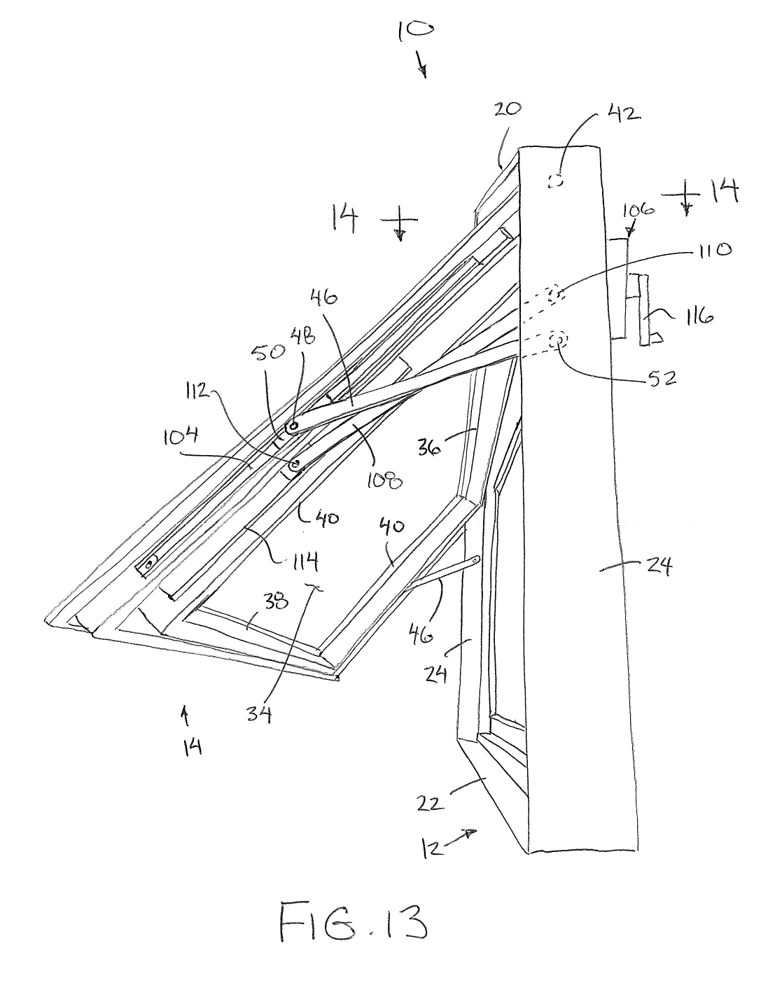

Turning now to FIGS. 13 through 15, a further embodiment of the window assembly 10 is illustrated in which the window assembly is again configured as an awning window so as to be very similar in configuration to the embodiment of FIGS. 10 through 12. Accordingly, the bottom end of the sash is displaced upwardly and outwardly towards the exterior of the building from the closed position to the open position.

The inner side of the profile forming each member of the perimeter frame 12 is again stepped in profile so as to define an inner portion 26 at the interior side of the window frame and an outer portion 28 which is located towards the outer side of the window frame and which is stepped outwardly to be increased in lateral width and height in opening size relative to the inner portion. A stepped face 30 is again defined between the inner and outer portions against which the sash is sealed by the sealing member 32 that is similarly configured to the previous embodiment. A second sealing member 33 in this instance may be provided at the outer periphery of the sash at the outer most side of the sash for abutment against the corresponding inward facing surface of the outer portion 28 at the exterior side thereof in the closed position of the window.

The sash 14 again includes a glass insert 34 received within the perimeter frame members of the sash which include a top member 36, a bottom member 38, and two side members 40 similar to the previous configuration. The perimeter frame members in this instance are stepped in profile to define a first face 100 parallel to and spaced slightly inwardly from the opposing face of the outer portion 28 of the frame 12 at the outer side of the window, and a second face 102 parallel to and spaced slightly inwardly from the opposing face of the inner portion 26 of the frame at the inner side of the window. A suitable gap is provided between the first face 100 and the outer portion 28 of the frame to receive the biasing mechanism as described below. A suitable gap is also provided between the second face 102 and the inner portion 26 of the frame to receive an operator mechanism for opening and closing the window as described below.

Similar to the previous embodiments, a pair of stub shafts 42 protrude laterally outwardly from opposing ones of the side members 40 adjacent the top end thereof to define a common horizontal pivot axis of the sash relative to the perimeter frame of the window. The shafts 42 are received within respective top pivot mounts 44 mounted on the side members 24 of the perimeter frame such that the pivotal connection is at a fixed location relative to the side members of each of the sash and the frame while coupling the sash pivotally to the frame. The shafts 42 defining the top pivot and the pivot mount 44 at each side of the window assembly are received within the gap between the first face 100 and the opposing face of the outer portion 28 of the frame.

Two link members 46 are again provided at laterally opposing sides of the sash such that each link member is pivotally mounted at a first pivot 48 at a first end of the link member on a first pivot mount 50 supported on the respective side member of the sash at an intermediate location spaced from both the top and bottom ends of the sash. Each link member is further pivotally mounted at a second pivot 52 at a second end of the link member on a second pivot mount 53 which is at a fixed location along the respective side member of the perimeter frame of the window assembly. The first pivot mounts 50 are each supported along the respective side member 40 of the sash for longitudinally sliding movement in a longitudinal direction of the side member 40 within the respective track member 104 mounted along the side member. The track member 104 is mounted on the first face 100 to locate the track and the sliding pivot mount 50 within the space between the first face 100 and the opposing face of the outer portion 28 of the perimeter frame 12. The link members are configured so that the first pivot 50 is below the second pivot 52 in the closed position, and so that the first pivot 50 is near in elevation or more preferably above the elevation of the second pivot 52 in the fully open position.

The biasing member 54 comprises a spring recoiling mechanism coupled to each sliding pivot mount 50 to bias the sliding pivot mount upwardly towards the top pivot. The bias of the spring coiling mechanism is mounted on the first face 100 between the side member of the sash and the outer portion 28 of the side member of the perimeter frame at the respective side of the window assembly.

As in previous embodiments, the sash is movable through a range of different intermediate positions that differ in spacing between the closed position and the open position. As the sash is initially displaced away from the open position, the sliding pivot mounts 50 slide upwardly and inwardly towards the top pivot under the urging of the biasing mechanisms which functions to continue to urge the window to continue towards the open position. Ideally the biasing mechanism provides sufficient biasing force to substantially carry the weight of the sash so as to enable the sash to be readily positioned at any selected position between the fully open and fully closed positions with minimal additional actuation force being required.

To provide the actuation force to position the sash at a selected position between the open and closed positions thereof, an operator mechanism 106 is provided at one side of the window assembly in operative connection between the side member 24 of the frame and the side member 40 of the sash. The operator mechanism is received within the gap between the second face102 of the sash and the corresponding face of the inner portion 26 of the frame.

More particularly, the operator mechanism 106 comprises a crank mechanism which is similar to the crank mechanism found on conventional casement windows which pivot about a vertical axis between open and closed positions thereof. Such conventional crank mechanisms for casement windows could not normally be used in operative connection between the side members of an awning window sash and frame due to the weight of the sash as it approaches the open position. In contrast to the prior art, the configuration of the biasing member 54 together with the sliding first pivot mounts 50 of the link members 46 described herein which carry most of the weight of the sash, allow a conventional crank mechanism of the type normally only used for casement windows to be effective for opening the awning window with the added benefit of providing no interference to the awning window being used as an egress window. That is, the operator mechanism 106 according to the present invention does not require any bottom linkage coupled between the bottom member of the sash and the bottom member of the perimeter frame 12 in the manner of a conventional operator mechanism for opening an awning window, and it is the absence of this bottom linkage which provides no obstruction and allows the awning window to be used as an egress window.

More particularly the operator mechanism 106 is mounted only at one side of the window mechanism. The operator mechanism 106 includes a link member 108 which is pivotally mounted at a first end 110 at the inner portion 26 of the side member of the frame and which is pivotally mounted at an opposing second end 112 in sliding relationship along a track 114 that is mounted on the second face 102 of the sash. An operator handle 116 is supported for rotation on the inner side of the corresponding side member 24 of the perimeter frame 12. The operator handle 116 is coupled through a suitable gear mechanism to the first end 110 of the link member to drive pivoting of the link member which displaces the sash between the open and closed positions as the second end 112 of the link member 108 is longitudinally slidable along the track 114 at the side of the sash 14.

The window assembly according to FIGS. 13 through 15 may further include a latch assembly of various configurations for retaining the sash in the closed position when locked.

Since various modifications can be made in my invention as herein above described, and many apparently widely different embodiments of same made, it is intended that all matter contained in the accompanying specification shall be interpreted as illustrative only and not in a limiting sense.

1. A window assembly comprising:
a frame extending about a perimeter of a window opening in the frame, the frame including a top member spanning laterally across a width of the frame above the window opening, a bottom member spanning laterally across a width of the frame below the window opening, and a pair of side members spanning a height of the frame between the top member and the bottom member of the frame at laterally opposing sides of the window opening respectively;
a sash including a top member spanning laterally across a top side of the sash, a bottom member spanning laterally across a bottom side of the sash, and a pair of side members spanning between the top member and the bottom member of the sash at laterally opposing sides of the sash respectively;
a top pivot pivotally coupling the side members of the sash to the side members of the frame adjacent top side of the window opening for pivotal movement about a laterally oriented pivot axis such that the sash member is movable relative to the frame between a closed position spanning across the window opening and an open position in which the bottom member of the sash is pivoted upwardly and away from the frame relative to the closed position such that the window opening is at least partially unobstructed by the sash;
at least one linkage arm including a first pivot at a first end of the linkage arm which is operatively connected for relative pivotal movement to one of the side members of the sash at an intermediate location between the top member and the bottom member of the sash and a second pivot at a second end of the linkage arm which is operatively connected for relative pivotal movement to one of the side members of the frame at an intermediate location between the top member and the bottom member of the frame;
one of the top pivot, the first pivot or the second pivot comprising a sliding pivot that is operatively connected to the respective side member upon which the pivot is supported so as to be longitudinally slidable relative the side member in a longitudinal direction of the side member; and
a biasing member operatively connected to the sliding pivot so as to bias the sliding pivot longitudinally inwards along the respective side member towards another one of the pivots on that side member so as to exert a biasing force acting on the sash in a direction urging the sash towards the open position.

2. The window assembly according to claim 1 wherein one of the top pivot or the second pivot comprises the sliding pivot, and the biasing member exerts a biasing force acting on the sash in the open position to retain the sash in the open position.

3. The assembly according to claim 2 wherein the sliding pivot is supported on a sliding member which is received within a hollow channel within the respective side member of the frame, the sliding member mating with the hollow channel so as to be linearly slidable along the channel.

4. The assembly according to claim 2 wherein the second pivot of said at least one linkage arm is the sliding pivot and wherein the biasing member biases the second pivot upwardly towards the top pivot in the open position of the sash.

5. The assembly according to claim 4 further comprising a lower stop member supported on the side member of the frame below the second pivot which is arranged to be engaged by the second pivot to prevent further downward sliding movement of the second pivot along the side member as the sash is displaced towards the closed position.

6. The assembly according to claim 4 further comprising an upper stop member supported on the side member of the frame above the second pivot which is arranged to be engaged by the second pivot to prevent further upwardly sliding movement of the second pivot along the side member beyond the open position of the sash.

7. The assembly according to claim 4 wherein the biasing member is supported within a hollow channel within the side member of the frame.

8. The assembly according to claim 4 wherein the biasing member is supported above the second pivot such that the biasing force pulls upwardly on the second pivot below the biasing member.

9. The assembly according to claim 4 wherein the biasing member is supported below the second pivot such that the biasing force pushes upwardly on the second pivot above the biasing member.

10. The assembly according to claim 4 wherein the top pivot is operatively connected to the side members of the frame so as to be longitudinally slidable relative to the side members of the frame in the longitudinal direction of the side members in addition to the second pivot which defines the sliding pivot operatively connected to the biasing member.

11. The assembly according to claim 10 further comprising a stop member supported on the side member of the frame below the top pivot so as to prevent downward sliding movement of the top pivot beyond the stop member.

12. The assembly according to claim 1 wherein the first pivot is operatively connected to the side member of the sash so as to be longitudinally slidable relative to the side member in a longitudinal direction of the side member.

13. The assembly according to claim 12 further comprising a stop member supported on the side member of the sash below the first pivot which is arranged to be engaged by the first pivot to prevent further sliding movement of the first pivot along the side member towards the bottom member of the sash in the open position of the sash.

14. The assembly according to claim 1 wherein the first pivot is fixed in longitudinal position along the side member of the sash.

15. The assembly according to claim 1 wherein the top pivot is the sliding pivot and wherein the biasing member biases the top pivot downwardly towards the second pivot in the open position of the sash.

16. The assembly according to claim 15 wherein the first pivot is fixed in longitudinal position along the side member of the sash.

17. The assembly according to claim 15 wherein the second pivot is fixed in longitudinal position along the side member of the frame.

18. The assembly according to claim 1 comprising a hopper window in which the bottom end of the sash is pivoted inwardly from the closed position to the open position.

19. The window assembly according to claim 1 wherein the first pivot is the sliding pivot and the biasing member urges the sliding pivot towards the top pivot.

20. The window assembly according to claim 19 comprising an awning window in which the bottom end of the sash is pivoted outwardly from the closed position to the open position, the window assembly further comprising an operator mechanism for opening the window which is operatively connected between one of the side members of the sash and one of the side members of the frame.
